(19) United States
(12) Patent Application Publication
(10) Pub. No.: US 2024/0399918 A1
(43) Pub. Date: Dec. 5, 2024

(54) CHARGING ARRANGEMENT AND METHOD FOR CONTROLLING CHARGING OF ELECTRIC VEHICLES AND COMPUTER PROGRAM PRODUCT

(71) Applicant: KEMPOWER OYJ, Lahti (FI)

(72) Inventors: Juhana ENQVIST, Lahti (FI); Juha VARKKI, Lahti (FI); Mikko VEIKKOLAINEN, Lahti (FI)

(21) Appl. No.: 18/696,214

(22) PCT Filed: Sep. 22, 2022
(86) PCT No.: PCT/FI2022/050639

§ 371 Date: Mar. 27, 2024

(30) Foreign Application Priority Data
Sep. 29, 2021 (FI) 20216007
Jun. 23, 2022 (FI) 20225573

(51) Int. Cl. B60L 53/66; B60L 53/65; B60L 53/67; G06Q 30/0283; G07F 15/00

(52) U.S. Cl. CPC B60L 53/665; B60L 53/65; B60L 53/67; G06Q 30/0284; G07F 15/005; B60L 2250/14

(57) ABSTRACT

A charging arrangement (1) for electric vehicles (2) comprises charging points (3, 4) connected to a common electric power supply connection (5). Each one of the charging points (3, 4) is configured to enable charging of one electric vehicle (2) at a time. The charging arrangement (1) also comprises at least one control unit (6) for controlling charging events at one or more of the charging points (3, 4). The control unit (4) is configured to receive at least charging resource data of the charging arrangement and charging event data about concurrent charging events at the charging points (3, 4) of the charging arrangement (1), to identify a change concerning the charging events; to determine dynamically in response to the identified change concerning the charging events a preferred charging mode for at least a first charging event on the basis of at least the charging resource data and concurrent charging event data; to generate output data configured to be provided for an end user of the first charging event, the output data enabling the end user to select between the determined preferred charging mode and at least one second charging mode; and to control, on the basis of a mode selection response indicating a selection of the preferred charging mode or the at least one second charging mode received from the end user, charging power supply of at least the first charging event.

### BACKGROUND

The present disclosure relates to providing charging services for electric vehicles, and more particularly to a charging arrangement and a method for controlling charging of electric vehicles. The present disclosure further concerns a computer program product.

The number of electrically rechargeable vehicles, driven partly or fully by electric energy, increases heavily around the world. These vehicles require charging points to recharge batteries of the vehicles. Besides private charging points, usually provided at or near the home or place of business of the vehicle end user, such as the owner and/or the driver, public charging points are needed to enable journeys exceeding the operating range of the battery of the vehicle. The increase in the number of rechargeable vehicles also increases the need for this type of public charging points. Such charging points may, thus, be provided at charging sites comprising a plurality of charging points provided close to each other to meet both the charging and maintenance needs.

A lot of electric power is needed at such charging sites, such as charging stations, providing charging services for electric vehicles and comprising a plurality of charging points. The charging power required by the charging site may be dimensioned according to the maximum power required by the charging points, when all the charging points are in use at maximum charging power. Alternatively, it may be defined that the maximum power required by each charging point cannot be in use simultaneously.

A problem related to using the combined maximum charging power of the charging points of the charging site as a basis for dimensioning the charging power of the charging site to a power grid is that this may affect the connection fee, use fees and possible other costs related. For instance, companies that provide electricity often charge for the use of electricity on the basis of the average of so-called peak power. The average peak power can be calculated, for example, from the average hourly or 15-minute consumption when the electricity consumption is at its highest. This average of the highest consumption may then be used for billing for instance for a month or a year, depending on the electricity contract. This type of an arrangement is disadvantageous for the provider of charging points, because although the demand for charging varies greatly according to the season, the time of day and so on, billing takes place according to the peak of demand.

In addition, potential costs to the charging point provider may incur if the electricity grid connection to the charging site is dimensioned according to a maximum charging capacity of all charging points being provided at a same time. The higher the maximum total charging power at the charging site is, the larger electricity connection is required, and the larger the equipment, such as transformers and possible energy storage to support peak demand, are needed to supply electricity. Equipment that providing higher power or capacity is always more expensive than smaller ones. The increased costs of obtaining and installing higher capacity equipment will affect the charging site service provider and indirectly the end user via the pricing of the charging electricity.

If, on the other hand, the charging power of the charging station is not dimensioned according to the maximum power required by the charging points, not all charging points of the charging station can be operated simultaneously at the maximum power. In this case, some of the charging points will have to be deactivated when the maximum amount of power is reached or, alternatively, some or all users of the charging points will have to reduce their charging power. This can lead to lower customer satisfaction and/or lower charging revenue when not all customers can be served.

Document CN109878369 B discloses calculating the price for charging power on the basis of several different variables, such as the market price of electricity, the selling price of the charging station, typical charging demand and charging capacity.

Document U.S. Pat. No. 9,821,677 BB discloses a system and method in which the charging of a vehicle takes place within a reserved time and in which the charging time and the amount of charging power can be automatically decided by the system.

Document U.S. Pat. No. 9,821,677 BB discloses a system and method in which a system estimates the price of electricity and initiates charging when the price of electricity reaches a certain level.

Document KR20160012355 A discloses a system and method for optimizing the electronic charging of a vehicle based on the supply of charging power, the price of electricity and other features, and implements the v2g (vehicle to grid) function if necessary.

Document EP2814687 discloses a system and method for arranging the monitoring and allocation of charging power in a distributed manner between a plurality of charging stations.

However, none of the known solutions enable taking different needs of different end users regarding charging of their electric vehicles in any way.

### BRIEF DESCRIPTION OF THE DISCLOSURE

An object of the present disclosure is to provide a new charging arrangement, method for controlling charging of electric vehicles and computer program product.

The object of the disclosure is achieved by a method, an arrangement and computer program product which are characterized by what is stated in the independent claims. Some embodiments of the disclosure are disclosed in the dependent claims.

The disclosure is based on the idea of defining a preferred charging mode for a charging event from the point of view of utilizing the charging power of the charging site in an optimal way and enabling an end user owning the charging event to affect the charging mode selection between the preferred charging mode and at least one other charging mode.

An advantage of the disclosure is that costs caused by connection to the electricity grid can be decreased by lowering the maximum charging power of the charging site while optimizing the charging capacity provided at each moment, as well as the customer satisfaction and the income from the charging by guiding the end users to use a charging power lower than the maximum charging power of the charging point when possible and feasible. This way the end user's needs may be met as well as possible while keeping the income from the charging site and the costs of the charging site at an optimal level.

### BRIEF DESCRIPTION OF THE DRAWINGS

In the following the disclosure will be described in greater detail by means of preferred embodiments with reference to the accompanying drawings, in which

FIG. 1 illustrates schematically a charging arrangement according to an embodiment;

FIG. 2 illustrates schematically an example of charging power consumption of charging events in a charging arrangement during a certain period of time;

FIG. 3 illustrates schematically a user interface according to an embodiment;

FIG. 4 illustrates schematically a charging arrangement according to an embodiment; and

FIG. 5 illustrates a method for controlling charging of electric vehicles.

The figures are provided for illustrating some features of the disclosure only and are not shown to scale. Same reference numbers are used for similar features in different figures and embodiments. Not all similar features are necessarily provided with reference numbers for the sake of clarity.

### DETAILED DESCRIPTION OF THE DISCLOSURE

The disclosure relates to charging of electric vehicles and, more particularly, to providing charging services for electrically driven vehicles. In this disclosure, electrically driven vehicles are called electric vehicles for the sake of simplicity. An electric vehicle, in the context of this disclosure, refers to an electrically rechargeable vehicle driven partly or fully by electric energy, thus including fully electric vehicles, so called plug-in hybrid vehicles and similar.

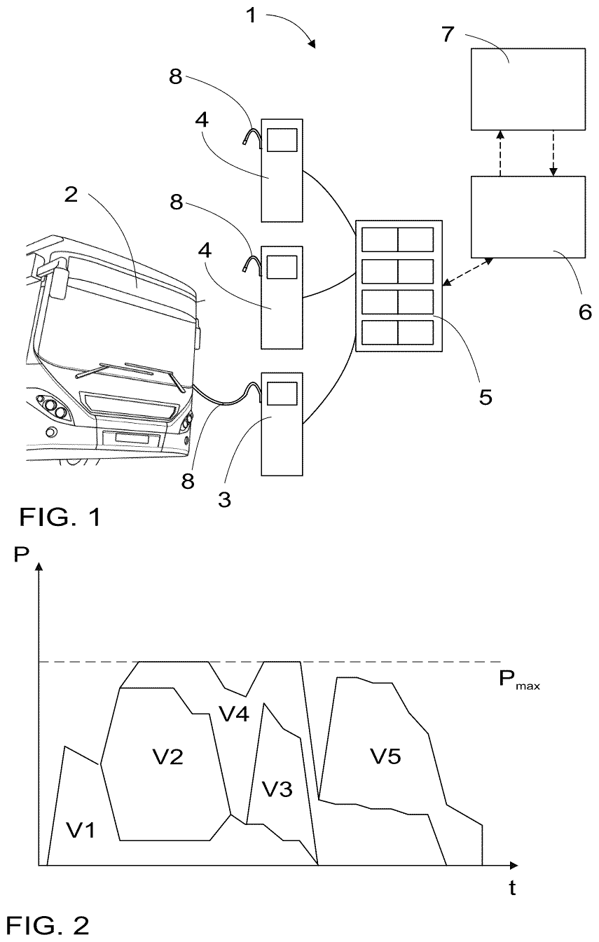

FIG. 1 illustrates schematically a charging arrangement 1 according to an embodiment. More particularly, FIG. 1 illustrates schematically a charging arrangement 1 at a charging site comprising a plurality of charging points 3, 4 for electric vehicles 2. FIG. 4 illustrates schematically a charging arrangement 1 according to an embodiment.

A charging arrangement 1 for electric vehicles 2, such as a charging arrangement 1 according to FIG. 4, may comprise two or more charging points 3, 4 connected to a common electric power supply connection 5. Each one of the charging points 3, 4 may be configured to enable charging of one electric vehicle 2 at a time. The two or more charging points 3, 4 may be configured to enable simultaneous use of the charging points 3, 4. In other words, two or more of the charging points 3, 4 may each be configured to be connected to an electric vehicle, respectively, and used for charging the electric vehicles 2 at the same time. Naturally, at a given time it is also possible that no electric vehicle 2 or only one electric vehicle 2 is being charged at the charging arrangement 1. According to an embodiment, the power supply connection 5 may comprise a power unit. The power unit may comprise multiple power modules. According to another embodiment, the power supply connection 5, such as the power unit, may be integrated in the charging points 3, 4.

The charging arrangement 1 may also comprise at least one control unit 6 for controlling charging events at one or more of the charging points 3, 4. Depending on the embodiment, the control unit 6 may be provided at the charging site comprising the charging arrangement or it may be provided remotely from the charging site. According to an embodiment, the control unit 6 may comprise the data processing means. According to an embodiment, the data processing means may comprise a programmable logic and/or programmable microprocessor, for example. According to an embodiment, the charging arrangement 1 may further comprise an external system 7 and the control unit 6 may be connected to the external system 7. According to an embodiment, the external system 7 may comprise a management system of the charging operator, public transport company system for electric vehicles or charging arrangement provider system that may control, for its own part, the electric power supply connection 5 to distribute charging power via the charging points. The charging power comprises charging current provided for the electric vehicle(s) at a selected charging voltage.

In this disclosure, a charging event refers to an event for charging an electric vehicle 2, in other words an electrically rechargeable vehicle, also called the vehicle, with electric energy. In other words, the charging event comprises an electronic charging event and the electric vehicle preferably comprises an electrically rechargeable vehicle. In FIG. 1, the electric vehicle 2 is a bus or similar, but depending on the embodiment, the electric vehicle 2 may comprise any type of a vehicle, such as a car or a truck.

Charging the electric vehicle 2, which may thus be configured to take place during the charging event, may comprise charging electric energy to energy storing means (not shown), typically a battery, of the electric vehicle 2. Different types of batteries for electric vehicles are generally known in the art and the type of the electric energy storing means is not relevant for the charging arrangement and method described. Therefore, the energy storing means are not described here in more detail.

The control unit 6 may be configured to receive at least charging resource data of the charging arrangement 1 and charging event data about concurrent charging events at the charging points 3, 4 of the charging arrangement. According to an embodiment, the charging resource data may comprise at least one of the following: data about a maximum charging power of the charging arrangement 1 and data about a predetermined target charging power of the charging arrangement 1.

According to an embodiment, the maximum charging power may comprise a maximum charging power defined by the power supply connection 5, a maximum charging power defined by an electricity contract with the electric power supplier, and a maximum charging power defined by other predetermined variables. According to an embodiment, the maximum charging power defined by other predetermined variables may comprise the maximum charging power configurable by changing, for instance by on operator, optimization variables for automatic optimization of charging events in the charging arrangement. In other words, the control unit 6 may be configured to enable updating at least one optimization variable determining maximum charging power for the charging arrangement and to store the updated optimization variable in a memory of the charging arrangement to be used for automatic optimization of the charging events.

According to an embodiment, the charging event data about concurrent charging events may comprise one or more of the following: number of ongoing charging events in the charging arrangement 1, current charging power of each ongoing charging event, planned duration of each ongoing charging event and planned changes in the charging power of each ongoing charging event.

The control unit 6 may further be configured to identify a change concerning the charging events.

The control unit 6 may further be configured to determine dynamically in response to the identified change concerning the charging events a preferred charging mode for at least a first charging event on the basis of at least the charging resource data and concurrent charging event data. According to a preferred embodiment, the first charging event may be a charging event taking place at a first charging point 3. In other words, the first charging point 3 comprises the charging point configured to perform the first charging event. According to an embodiment, the first charging event may comprise a new charging event, such as a starting charging event, or an ongoing charging event. It is clear for a person skilled in the art that the expression first does not refer to an order in which the charging event are started or ended.

According to an embodiment, the charging mode may comprise at least one of a charging power and a charging time. The preferred charging mode refers to a charging mode for a charging event, which is optimal from the point of view of utilizing the charging power of the charging site in an optimal way. In other words, the preferred charging mode changes over time depending on the charging event data about concurrent charging events at the charging points 3, 4 of the charging arrangement 1. Thus, according to an embodiment, the preferred charging mode comprises a duration of the planned charging event and/or a charging power rate for the charging event, which optimally utilizes the charging power available in the charging arrangement considering the ongoing charging events. According to an embodiment, the control unit 6 is configured to also consider the capability of the electric vehicle to receive charging power, such as the maximum charging power intake rate of the electric vehicle make and model in question and/or the current state of the energy storing means of the electric vehicle, when determining the preferred charging mode. The current state of the energy storing means may be relevant, since nearly fully charged energy storing means may in some cases receive charging power at a lower rate than 20 percent full energy storing means, for example.

According to an embodiment, the control unit 6 may also be configured to consider the date and time, such as busy days or hours, when determining the preferred charging mode.

According to an embodiment, the control unit 6 may further be configured to generate output data configured to be provided for an end user of the first charging event, the output data enabling the end user to select between the determined preferred charging mode and at least one second charging mode.

According to an embodiment, the control unit 6 may then further be configured to control, on the basis of a mode selection response indicating a selection of the preferred charging mode or the at least one second charging mode received from the end user, charging power supply of at least the first charging event.

FIG. 2 illustrates schematically an example of charging power consumption of charging events in a charging arrangement during a certain period of time. In FIG. 2, the maximum charging power of the charging arrangement 1 is show as Pₘₐₓ. In the embodiment of FIG. 2, the maximum charging power of the charging arrangement remains the same of the time t shown on the x-axis. The y-axis represents the charging power P. Each one of the areas V1, V2, V3, V4 and V5 represents one charging event for one electric vehicle, respectively. For instance, when the first electric vehicle, the charging event for which is represented by V1, arrives to a first charging point 3, all the other charging points 4 are free. The height of each area V1, V2, V3, V4 and V5 in the direction of the axis P, namely the difference between the highest point and the lowest point of the area in question, at each point of the axis t represents the charging power P for the electric vehicle in question at that point of time. Connecting the electric vehicle 2 to the first charging point 3 may form a first change concerning charging events. The control unit 6 may, then, be configured to determine a preferred charging mode for this charging event and provide output data for the end user of the first vehicle as described in an embodiment of this description.

According to an embodiment, the charging arrangement 1 may be configured to supply charging power to the electric vehicle at a charging power higher than the rate associated with the selected charging mode at the price associated with the selected charging mode, if the charging arrangement 1 has excess capacity at the time and if the electric vehicle is capable of receiving electric charge at this higher charging rate. This may be beneficial because higher charging rate speeds up the charging event, which rarely causes any problems, and it frees up charging capacity for a later point of time when there might be more charging events ongoing simultaneously.

Further referring to FIG. 2, when the second vehicle arrives to the charging arrangement 1 and connects to one of the further charging points 4, this may form a second change concerning the charging events. The second change concerning the charging events may initiate determining a preferred charging mode for the second vehicle and/or determining an updated preferred charging mode for the first vehicle, as described in and embodiment of this description.

According to an embodiment, the determined output data may be configured to guide the end user to select the preferred charging mode for the new charging event. For example, the determined output data may comprise a benefit offered for the end user for selecting the preferred charging mode. Depending on the embodiment, this benefit may comprise a lower price, a discount for charging or other services, additional services, loyal customer point and/or other benefits. According to an embodiment, the benefit may further comprise a discounted price for an end user selecting to delay start of a charging event and possibly giving his/her place in a charging queue for another end user.

According to an embodiment, the charging arrangement 1, preferably the control unit 6, may be configured to perform an automatic optimization of the charging events in the charging arrangement 1 in response to an identified change concerning the charging events, such as the first change, the second change or a further change concerning the charging events. According to an embodiment, the control unit 6 may further be configured, to perform the automatic optimization of the charging events, to compare charging resource data and/or concurrent charging event data with predetermined criteria or algorithm for optimizing utilizing of charging power of the charging arrangement to determine dynamically in response to an identified change concerning the charging events, such as the first change, the second change or a further change concerning the charging events, a need or a possibility to change the charging mode of at least one of the ongoing charging events, such as the first charging event, to an updated charging mode for optimizing utilizing of charging power of the charging arrangement 1. According to an embodiment, the charging arrangement 1, preferably the control unit 6, may be configured to check that the updated charging mode does not affect fulfilling the charging mode selections made by the end users.

According to an embodiment, the automatic optimization of the charging events may comprise comparing charging resource data and/or concurrent charging event data with predetermined criteria, such as the optimizing variable(s), or algorithm for optimizing utilizing of charging power of the charging arrangement to determine dynamically in response to an identified change concerning the charging events, such as the first change, the second change or a further change concerning the charging events, charging powers for at least one, preferably several, and most preferably for all ongoing charging events in such a manner that the maximum charging power of the charging arrangement is utilized in an optimal way. According to an embodiment, utilizing the maximum charging power of the charging arrangement in an optimal way comprises utilizing the whole maximum charging power or as much of it as possible considering charging resource data and/or concurrent charging event data, such as considering the maximum charging power each electric vehicle can receive or considering the charging mode selections made, to release as much of the charging power of the charging arrangement as early as possible for further charging events, such as future charging events.

According to an embodiment, the charging arrangement 1, preferably the control unit 6, is configured to enable updating of the predetermined criteria, for instance by an operator of the charging arrangement. According to an embodiment, updating the predetermined criteria may comprise for instance determining whether all of the maximum charging power of the charging arrangement is used as early as possible or if a different optimizing strategy is preferred.

According to an embodiment, the charging arrangement 1 may be configured to temporarily pause a charging event, such as the first charging event or another ongoing charging event of the charging arrangement, and resume the charging event at a later point of time in response to determining the pausing or resuming of the charging event to be optimal from the point of view of utilizing the charging power of the charging event, such as the charging site, based on predetermined criteria and/or algorithm. In other words, the automatic optimization of the charging events may comprise pausing and/or resuming at least one charging event, such as the first charging event and/or another ongoing charging event. More particularly, according to an embodiment, the control unit 6 may further be configured to compare charging resource data and/or concurrent charging event data with predetermined criteria or algorithm for optimizing utilizing of charging power of the charging arrangement to determine dynamically in response to an identified change concerning the charging events, such as the first change, the second change or a further change concerning the charging events, a need to pause and/or resume a charging event, which charging event may comprise the first charging event or another ongoing charging event.

According to an embodiment, the determined output data comprises price information, whereby the output data is configured to guide the end user to select the preferred charging mode on the basis of the price information. According to an embodiment, the preferred charging mode may be associated with price information indicating a lower price for the charging event as a whole and/or for a predetermined amount of charging power. According to an embodiment, the pricing may be dynamic. In other words, the pricing of the charging of a given amount of electric power at a given charging power rate and/or in a given period of time may be configured to depend on the other ongoing charging events at the charging arrangement 1 and/or known peak times. For example, according to an embodiment, the price of charging with a maximum power of a charging point 3, 4 may be associated with a higher price, when the combined charging power of the charging points of the charging arrangement is high, than when there are no other charging events ongoing at the charging arrangement, such as at the charging site. According to another embodiment, the price of charging during a peak time of a charging point 3, 4 may be associated with a higher price, when the first charging event is started during a peak time or when a peak time is determined to overlap with the duration of the first charging event, than during other times. A peak time may comprise a time of day, such as a rush hour, a day, such as a national holiday, or a period, such as a holiday season, during which more charging events may be expected. The peak time may comprise a local peak time related to the area of the charging arrangement, such as a local event, or a general peak time, such as time closely before or after regular office hours.

According to an embodiment, the determined output data comprises, in addition to or instead of the price information, information about an estimated charging time and/or charging power. According to an embodiment, the determined output data may comprise at least two combinations of a charging time and an associated price for the charging, wherein one of the combinations represents the preferred charging mode, in other words the preferred charging mode from the charging arrangement 1 point of view.

An advantage of such embodiments is that the consumption behaviour of the end user may be guided by providing the end user with output data including alternative charging modes and receiving charging mode selection from the end user in such a manner that the charging event may be finished in a time acceptable for the end user. According to an embodiment, the price of the charging event may depend on the maximum, average and/or cumulative charging power provided during the charging event and the duration of the charging event. For example, a lower charging power, and thus slower charging, may be offered for the end user at a lower price and a higher charging power at a higher cost. Also, showing the charging modes in terms of charging time instead of charging power may be easier for the end user to understand and evaluate with respect to his/her needs and schedule. At least some end users typically prefer a lower price over a quick charging event, especially if they are not busy, or plan to stay a longer time at the location. Thereby, at least a part of the charging events may be provided with a lower charging power leaving more of the maximum charging power, in other words more of the capacity, of the charging arrangement 1 for other charging events and, thus, other end users needing charging services.

According to an embodiment, the control unit 6 may further be configured to generate control commands configured to control charging power supply of the first charging event, and to provide control commands for at least the first charging point 3. According to an embodiment, the control unit 6 may further be configured to generate the control commands configured to control charging power supply of the first charging event on the basis of at least the mode selection response or the charging resource data and the charging event data at a given moment during the charging. According to a further embodiment, the control unit 6 may further be configured to generate a control command configured to change the charging power supply of the first charging event during the first charging event in response to identifying a second change concerning charging events.

According to an embodiment, the control unit 6 may be further configured to identify a second change concerning the charging events during the first charging event and to determine dynamically in response to the identified second change concerning the charging events an updated preferred charging mode for at least the first charging event on the basis of at least the charging resource data and updated concurrent charging event data. The control unit 6 may then be configured to generate updated output data configured to be provided for the end user of the first charging event, the updated output data enabling the end user to select between the determined updated preferred charging mode and at least one second updated charging mode, and to control, on the basis of an updated mode selection response indicating a selection of the updated preferred charging mode or the at least one second updated charging mode received from the end user, charging power supply of at least the first charging event.

According to an embodiment, the charging mode may comprise at least one of a charging power and a charging time.

According to an embodiment, the electric vehicle 2 may be connected to the charging point 3, 4 via a charging connector (not shown). In other words, the end user arriving at the charging point 3, 4, for example at the first charging point 3, may connect the electric vehicle 2 to the charging point by a charging cable 8. Depending on the embodiment, the charging cable may be attached fixedly to the charging point 3, 4 at its first end and comprise a charging connector to be attached to the electric vehicle 2, or the charging cable 8 may comprise a charging connector at both of its ends, wherein one of the charging connectors is configured to be attached to the electric vehicle 2 and the other to the charging point 3, 4. According to a further embodiment, the electric vehicle 2 may be connected to the charging point 3, 4 to receive electric power from the charging point 3, 4 in another manner than by a charging cable 8. Connecting an electric vehicle 2 to a charging point 3, 4 is widely known in the art and is, thus, defined here in more detail.

According to an embodiment, the charging point 3, 4 and/or the control unit 6 may further be configured to receive data enabling identifying a make and/or model of the electric vehicle 2 in response to the electric vehicle 2 being connected to the charging point, for instance the first charging point 3. The data enabling identifying the make and/or the model of the electric vehicle 2 may be received to the charging point and/or the control unit for instance from the electric vehicle 2 via the charging cable 8, via a charging software provided in the charging point 3 or in a mobile device (not shown) of the end user or via another type of a wireless connection. The charging software may comprise a mobile device application, a charging point application, a website or other suitable form of software capable of providing information for and receiving input from the end user.

According to an embodiment, the control unit 6 may be further configured to identify the make and/or the model of the electric vehicle 2 and the current state of the energy storing means of the electric vehicle 2 in response to connecting the electric vehicle to the first charging point 3. In such an embodiment, the preferred charging mode may further be determined on the basis of at least one of the following: make of the electric vehicle, model of the electric vehicle, and the current state of the energy storing means of the electric vehicle. The energy storing means may comprise as at least one battery of the electric vehicle 2. The current state of the energy storing means may comprise information about the current charge of the energy storing means, such as how many kWh or what percentage of the capacity of the energy storing means is charged, for instance at a time when the electric vehicle 2 is connected to the charging point 3, 4. The capacity of the energy storing means 4 refers to the maximum or nominal amount of energy the energy storing means of the vehicle 10, such as the at least one battery of the vehicle, is capable of storing. The capacity of the energy storing means of electric vehicles 2, in other words, electrically rechargeable vehicles, is often described in kWh.

According to an embodiment, the control unit 6 may further be configured to retrieve the capacity for the batter of the electric vehicle 2 with the make and/or model in question from a memory of the charging arrangement 1 or from an external database 7. The control unit 6 may then be configured to determine the preferred charging mode on the basis of at least one of the following: make of the electric vehicle, model of the electric vehicle, capacity of the energy storing means of the electric vehicle and the current state of the energy storing means of the electric vehicle. According to a further embodiment, the control unit 6 may be configured to determine the preferred charging mode on the basis of the make and/or model of the electric vehicle, capacity of the energy storing means of the electric vehicle and the current state of the energy storing means of the electric vehicle.

According to an embodiment, the charging arrangement 1, and more particularly the control unit 6, may be configured to determine, on the basis of the make and/or the model of the electric vehicle 2, the current capacity of the energy storing means of the electric vehicle and the available charging power of the charging arrangement 1 remaining after possible other ongoing charging events how long it would take from the first charging point 3 to recharge the energy storing means of the electric vehicle 2 to a predetermined charging state, such as to filling the energy storing means to maximum capacity, to 80 percent, to 50 percent or a different value.

According to an embodiment, the charging arrangement 1 may further comprise a user interface 30 configured to display at least one of the output data and the updated output data to the end user and to receive at least one of the mode selection response or the updated mode selection response from the end user. According to an embodiment, the user interface 30 may be configured to display at least one of the output data and the updated output data to the end user as a push notification. According to an embodiment, the user interface 30 may be provided in connection with the charging point 3, 4, for instance on a display device of the charging point, on a display device of a different device forming a part of the charging arrangement 1, or in a charging software. The charging software may comprise a mobile device application, a charging point application, a website or other suitable form of software capable of providing information for and receiving input in the form of mode selection response from the end user.

According to an embodiment, the determined output data may, thus, comprise at least two combinations of a charging time and an associated price for the charging, wherein one of the combinations represents the preferred charging mode, in other words the preferred charging mode determined from the charging arrangement 1 point of view.

According to an embodiment, the combinations of charging time and associated price may be determined on the basis of the current state of the energy storing means of the electric vehicle 2, in other words on the basis of the maximum amount of charging power that can be charged to the energy storing means of the electric vehicle 2 at a given time. The control unit 6 may be configured to determine the maximum amount of charging power that can further be charged to the electric vehicle 2 on the basis of the current state of the energy storing means of the electric vehicle and the make and/or model of the electric vehicle and/or the capacity of the energy storing means of the electric vehicle.

According to an embodiment, the combinations of charging time and associated price may further be determined on the basis of received further input from the end user. In other words, the user interface 30 may be configured to first receive a first piece of output data generated by the control unit 6 and to display the first piece of output data enabling the end user to select the percentage of the capacity of the energy storing means of the electric vehicle 2, up to which the end user wishes to charge the energy storing means. The user interface 30 may then be configured to receive a capacity selection from the end user and provide it to the control unit 6. The control unit 6 may, thus, be configured to receive this capacity selection, and to determine the preferred charging mode on the basis of the capacity selection in addition to the charging resource data and the concurrent charging event data. The control unit 6 may then further be configured to generate a second piece of output data enabling the end user to select between the determined preferred charging mode and at least one second charging mode. The user interface 30 may be configured to display the second piece of output data and to receive the charging mode selection from the end user.

For instance, the capacity of the energy storing means of an electric vehicle may be 70 kWh, which thus could be considered a 100 percent charge. The current state of the energy storing means of the electric vehicle may be 10 kWh, in other words approximately 14 percent. Thus, the maximum amount of energy that can be charged to the energy storing means of the electric vehicle 2 is 60 kWh. If the end user selects that the percentage of the capacity of the energy storing means of the electric vehicle 2, up to which the end user wishes to charge the energy storing means, is 80 percent, 46 kWh should be charged. This 46 kWh may be charged using a maximum charging power or another selected charging power rate. The time the charging takes depend on the charging power rate. According to an embodiment, the charging power rate may be changed during charging event automatically or by determining a new preferred charging mode, generating new output data accordingly and providing the new output data to the end user via the user interface 30 enabling the end user to provide a new mode selection response.

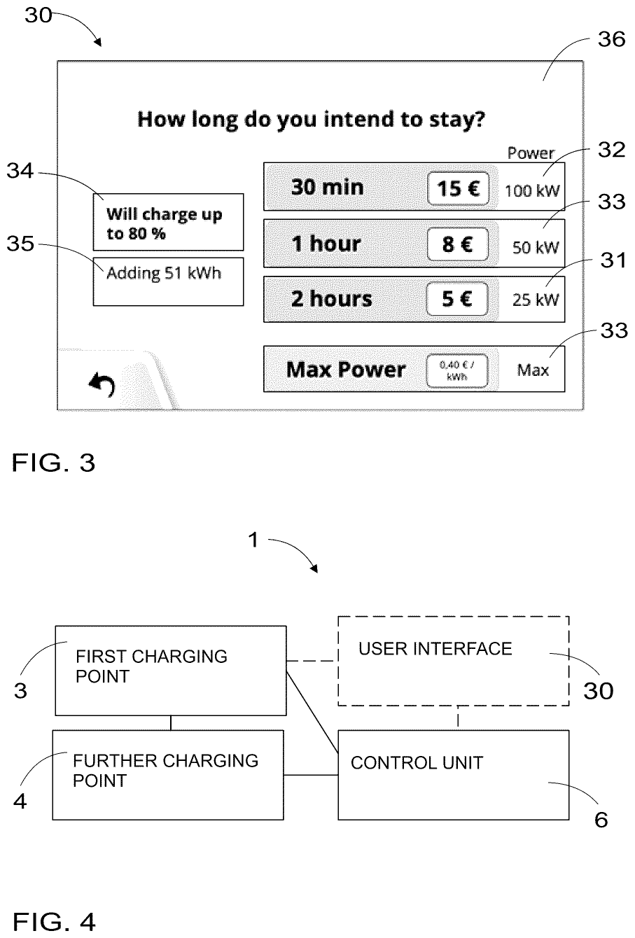

Referring now to FIG. 3, the user interface 30 may comprise at least a first selection object 31 and a second selection object 32. The first selection object 31 may be configured to display output data related to the preferred charging mode and the second selection object 32 may be configured to display output data related to the second charging mode. The end user making a selection using the first selection object 31 may be configured to generate the mode selection response indicating the selection of the preferred charging mode and the end user making a selection using the second selection object 32 may be configured to generate the mode selection response indicating the selection of the second charging mode.

The user interface may also comprise further selection objects 33 for displaying output data related to and enabling selection of further charging modes defined by the control unit 6 on the user interface 30. One of the further charging modes may comprise a maximum charging power of the charging point 3, 4 being used during the charging event. The end user making a selection refers the end user affecting, using the user interface 30, the corresponding selection object 31, 32, 33. Ways of end user affecting a selection object for making a selection using a user interface are widely known in the art and may include, but are not limited to, at least one of the following: making a selection using a physical selection device, such as a computer mouse, a pointer, a keyboard or similar, touching the area of the selection object on a touch screen, making a gesture, such as hovering over, close to the selection object on the user interface, and so on. According to an embodiment, the user interface 30 may be provided on a display 36, such as a display of a charging point 3, 4, a display of another device of the charging arrangement 1, a display of a mobile device on a computer display or other suitable display.

According to an embodiment, the control unit 6 and/or the user interface 30 may be configured to hide or prevent selecting a charging mode related to one or more of the selection objects 31, 32, 33 in response to the charging mode in question being determined by the control unit 6 as an impossible or non-optimal charging mode for the charging arrangement 1 at the current time and/or during the planned duration of the charging event, such as the first charging event or another charging event ongoing at the charging arrangement 1, such as at the charging site.

The user interface 30 may further comprise display objects, such as a first display object 34 and further display objects 35. In an embodiment, wherein the end user is enabled to first make the capacity selection on the user interface 30, this selection may be displayed in the first display object 34. Other relevant information may be displayed in further display objects 35. It is clear for a person skilled in the art that FIG. 3 only shows a schematic example of a user interface for the purpose of clarifying the concept, and that in different embodiments the selection objects 31, 32, 33, the display objects 34, 35 and possible other objects, their number, appearance, and order may differ substantially from this example.

According to an embodiment, the change concerning the charging events may comprise at least one of the following: initiation of a new charging event at one of the charging points, ending a charging event at one of the charging points and changing the charging power supply for one of the charging points.

According to an embodiment, the control unit 6 may further be configured to start the first charging event using maximum charging power of the first charging point 3 if no mode selection response is received from the end user withing a predetermined amount of time from providing the charging modes on the user interface 30.

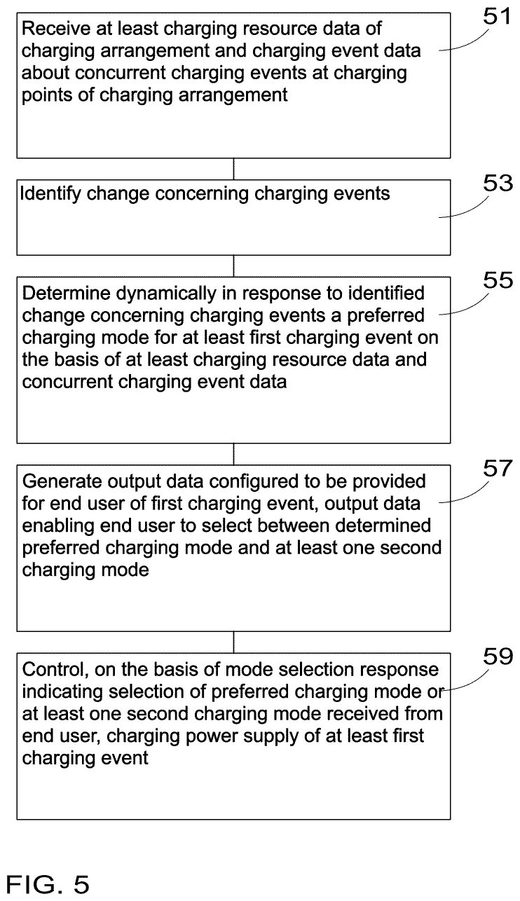

FIG. 5 illustrates a method for controlling charging of electric vehicles. The method may be implemented by a charging arrangement 1 and/or a computer program product. The charging arrangement 1 comprises two or more charging points 3, 4 connected to a common electric power supply connection 5, wherein each one of the charging points 3, 4 is configured to enable charging of one electric vehicle 2 at a time, and wherein the two or more charging points 3, 4 are configured to enable simultaneous use of the charging points 3, 4. The charging arrangement 1 further comprises at least one control unit 6 for controlling charging events at one or more of the charging points 3, 4.

A method for controlling charging of electric vehicles, such as the method of FIG. 5, may comprise receiving 51 by the control unit 6 at least charging resource data of the charging arrangement and charging event data about concurrent charging events at the charging points 3, 4 of the charging arrangement 1.

The method may further comprise identifying 53 by the control unit 6 a change concerning the charging events and determining 55 by the control unit 6 dynamically in response to the identified change concerning the charging events a preferred charging mode for at least a first charging event on the basis of at least the charging resource data and concurrent charging event data.

The method may also comprise generating 57 by the control unit 6 output data configured to be provided for an end user of the first charging event, the output data enabling the end user to select between the determined preferred charging mode and at least one second charging mode, and controlling 59 by the control unit, on the basis of a mode selection response indicating a selection of the preferred charging mode or the at least one second charging mode received from the end user, charging power supply of at least the first charging event.

According to an embodiment, a computer program product may comprise instructions which, when the program is executed by a computer, cause the computer to carry out the steps of a method disclosed in this disclosure.

An advantage of the disclosed embodiments is that consumption behaviour of end users charging their electric vehicles can be guided in such a manner that the charging site service provider could avoid high costs from electric grid connection and usage and, at the same time, provide better customer satisfaction and increased income from the charging points.

It is obvious for a person skilled in the art that, as the technology advances, the concept of this disclosure may be implemented in various ways. The disclosed solution and its embodiments are not limited to the examples described in this description but may vary within the scope of the claims.

1. A charging arrangement for electric vehicles, wherein the charging arrangement comprises two or more charging points connected to a common electric power supply connection, wherein each one of the charging points is configured to enable charging of one electric vehicle at a time, and wherein the two or more charging points are configured to enable simultaneous use of the charging points, and at least one control unit for controlling charging events at one or more of the charging points, characterized in that the control unit is configured to:
receive at least charging resource data of the charging arrangement and charging event data about concurrent charging events at the charging points of the charging arrangement;
identify a change concerning the charging events;
determine dynamically in response to the identified change concerning the charging events a preferred charging mode for at least a first charging event on the basis of at least the charging resource data and concurrent charging event data;
generate output data configured to be provided for an end user of the first charging event, the output data enabling the end user to select between the determined preferred charging mode and at least one second charging mode; and
control, on the basis of a mode selection response indicating a selection of the preferred charging mode or the at least one second charging mode received from the end user, charging power supply of at least the first charging event.

2. The charging arrangement according to claim 1, wherein the determined output data is configured to guide the end user to select the preferred charging mode for the new charging event.

3. The charging arrangement according to claim 1, wherein the determined output data comprises price information, whereby the output data is configured to guide the end user to select the preferred charging mode on the basis of the price information.

4. The charging arrangement according to claim 1, wherein the control unit is configured to generate control commands configured to control charging power supply of the first charging event, and to provide control commands for at least the first charging point.

5. The charging arrangement according to claim 4, wherein the control unit is configured to generate the control commands configured to control charging power supply of the first charging event on the basis of at least the mode selection response or the charging resource data and the charging event data at a given moment during the charging.

6. The charging arrangement according to claim 4, wherein the control unit is configured to generate a control command configured to change the charging power supply of the first charging event during the first charging event in response to identifying a second change concerning charging events.

7. The charging arrangement according to claim 1, wherein the control unit is further configured to enable updating at least one optimization variable determining maximum charging power for the charging arrangement and to store the updated optimization variable in a memory of the charging arrangement to be used for automatic optimization of the charging events.

8. The charging arrangement according to claim 1, wherein the preferred charging mode comprises at least one of a charging power and a charging time.

9. The charging arrangement according to claim 1, wherein the control unit is further configured to identify a make and/or a model of the electric vehicle and a current state of an energy storing means of the electric vehicle in response to connecting the electric vehicle to the first charging point, and wherein the preferred charging mode is further determined on the basis of at least one of the following: make of the electric vehicle, model of the electric vehicle, and a capacity of the energy storing means of the electric vehicle.

10. The charging arrangement according to claim 1, wherein the charging arrangement further comprises a user interface configured to display the output data to the end user and to receive the mode selection response from the end user.

11. The charging arrangement according to claim 10, wherein the user interface is configured to display at least one of the output data and the updated output data to the end user as a push notification.

12. The charging arrangement according to claim 1, wherein the change concerning the charging events comprises at least one of the following: initiation of a new charging event at one of the charging points, ending a charging event at one of the charging points, and changing the charging power supply for one of the charging points.

13. The charging arrangement according to claim 12, wherein the control unit is further configured to perform an automatic optimization of the charging events in the charging arrangement in response to an identified change concerning the charging events.

14. The charging arrangement according to claim 13, wherein the automatic optimization of the charging events comprises comparing charging resource data and/or concurrent charging event data with predetermined criteria or algorithm for optimizing utilizing of charging power of the charging arrangement to determine dynamically in response to an identified change concerning the charging events charging powers for at least one charging event in such a manner that the maximum charging power of the charging arrangement is utilized in an optimal way.

15. The charging arrangement according to claim 14, wherein the control unit is configured to enable updating of the predetermined criteria.

16. A method for controlling charging of electric vehicles, wherein the charging arrangement comprises two or more charging points connected to a common electric power supply connection, wherein each one of the charging points is configured to enable charging of one electric vehicle at a time, and wherein the two or more charging points are configured to enable simultaneous use of the charging points, and at least one control unit for controlling charging events at one or more of the charging points, characterized in that the method comprises:
receiving by the control unit at least charging resource data of the charging arrangement and charging event data about concurrent charging events at the charging points of the charging arrangement;
identifying by the control unit a change concerning the charging events;
determining by the control unit dynamically in response to the identified change concerning the charging events a preferred charging mode for at least a first charging event on the basis of at least the charging resource data and concurrent charging event data;
generating by the control unit output data configured to be provided for an end user of the first charging event, the output data enabling the end user to select between the determined preferred charging mode and at least one second charging mode, and
controlling by the control unit, on the basis of a mode selection response indicating a selection of the preferred charging mode or the at least one second charging mode received from the end user, charging power supply of at least the first charging event.

17. A computer program product comprising instructions which, when the program is executed by a computer, cause the computer to carry out the steps of the claim 16.
